(19) United States
(12) Patent Application Publication
(10) Pub. No.: US 2007/0095620 A1
(43) Pub. Date: May 3, 2007

(54) Conveyer belt brake

(76) Inventor: Hubert de Villiers Barnard, Pretoria (ZA)

Correspondence Address: BROOKS KUSHMAN P.C., 1000 TOWN CENTER, TWENTY-SECOND FLOOR, SOUTHFIELD, MI, 48075, US

(21) Appl. No.: 10/595,257

(22) PCT Filed: Sep. 30, 2004
(86) PCT No.: PCT/IB04/03188

§ 371 Date: Mar. 31, 2006

(30) Foreign Application Priority Data
Oct. 1, 2003 (ZA) 20037667

(51) Int. Cl. F16D 51/00

(52) U.S. Cl. 188/74

(57) ABSTRACT

Conveyer belt braking apparatus comprises an idler roller (10) rotatable about an axle, and a brake member (40) mounted adjacent the idler roller and movable relative to the roller between a first, inoperative position adjacent a belt supported by the roller and a second, braking position against the belt. An operating mechanism (26, 28) is arranged to sense the direction of rotation of the roller and to move the brake member from the first, inoperative position to the second, braking position when the direction of rotation of the roller reverses in use. Preferably the mechanism includes a clutch bearing (26) that engages to move the brake member from the first inoperative position to the second, braking position thereof when the roller reverses direction.

### BACKGROUND OF THE INVENTION

THIS invention relates to conveyer belt braking apparatus.

Conveyer belts supported by idler rollers are widely used for transporting material in mining, quarrying and many other industries. The idler rollers are mounted on frames and support the conveyer belt which is typically driven by a head pulley.

Particularly where conveyer belts are inclined and carry relatively heavy loads, the consequences of a belt breakage can be severe. In the case of an inclined conveyor belt, breakage normally takes place in the vicinity of the head pulley, with the result that the upper and lower runs of the belt tend to slip back under gravity over the idler rollers. The normal slippage of the belt is assisted by the stored tension in the unbroken belt which is released when the belt is broken. The result, if the broken belt is not arrested in some way, is that the broken belt slips back all the way to the lowest point. A breakage resulting in a runaway of the belt and its load can cause substantial damage to the lower idlers and nearby equipment, and possible injury to nearby personnel.

Various conveyer belt braking systems have been proposed to deal with the problem of belt breakages. Known systems of this kind range from relatively large and complex braking mechanisms to relatively simple brakes acting on the idler rollers themselves.

It is an object of the invention to provide an alternative conveyer belt braking apparatus.

### SUMMARY OF THE INVENTION

According to the first aspect of the invention there is provided conveyer belt braking apparatus comprising:
an idler roller rotatable about an axle;
a brake member mounted adjacent the idler roller and movable relative to the roller between a first, inoperative position adjacent a belt supported by the roller and a second, braking position against the belt; and
an operating mechanism arranged to sense the direction of rotation of the roller and to move the brake member from the first, inoperative position to the second, braking position when the direction of rotation of the roller reverses in use.

Preferably, the brake member is arranged to be located between the belt and the roller when the brake member is in the second, braking position.

The brake member may be a plate mounted parallel to the roller and pivotable between the first and second positions.

Preferably, the plate is pivotable about an axis that coincides substantially with the axle of the roller.

The plate is preferably connected to a shaft that extends through a bore in the axle of the idler roller, the shaft being rotatable relative to the axle, with a one-way clutch mechanism within the body of the idler roller fixed to the shaft and to the body of the roller, so that the roller can rotate freely relative to the shaft in a forward direction but, when the roller rotates in a reverse direction, the clutch engages, causing the shaft to rotate and to move the brake member from the first, inoperative position to the second, braking position thereof.

Alternatively, the plate may be connected to a sleeve fitted about the axle, the sleeve being rotatable relative to the axle, with a one-way clutch mechanism within the body of the idler roller fixed to the sleeve and to the body of the roller, so that the roller can rotate freely relative to the sleeve in a forward direction but, when the roller rotates in a reverse direction, the clutch engages, causing the sleeve to rotate and to move the brake member from the first, inoperative position to the second, braking position thereof.

The apparatus may include at least one locking member associated with the idler roller and arranged to engage the brake member and to hold the brake member in the second, braking position thereof when the brake member moves from the first, inoperative position thereof to the second, braking position thereof.

Preferably, said at least one locking member comprises a bracket fixable to the axle of the roller and having a projection that engages a portion of the brake member when the brake member moves to the second, braking position thereof.

According to a second aspect of the invention there is provided conveyer belt braking apparatus comprising:
a brake member mountable adjacent the return path of a conveyer belt and movable relative to the conveyer belt between a first, inoperative position adjacent the return path of the belt and a second, braking position in which the brake member engages the belt frictionally; and
an operating mechanism responsive to a belt breakage to move the brake member from the first position to the second, braking position thereof.

The brake member may be a plate mounted adjacent and transverse to the return path of the conveyer belt, the brake member being pivotable between the first and second positions.

The operating mechanism may be a linkage connecting the brake member to a brake member of a conveyer belt braking apparatus such as that defined above.

### BRIEF DESCRIPTION OF THE DRAWINGS

FIG. 1 is a pictorial view of a conveyer idler arrangement including a conveyer idler roller provided with braking apparatus according to a first embodiment of the invention;

FIG. 2 is a pictorial view of the centre conveyer idler shown in FIG. 1, with the braking apparatus thereof in a first, inoperative position;

FIG. 3 is a similar view to that of FIG. 2, showing the brake member in a second, braking position thereof;

FIG. 4 is a partially cutaway pictorial view corresponding to FIG. 2, showing the construction of the braking apparatus;

FIGS. 5a to 5c are end views of the roller shown in FIGS. 2 to 4, showing the operation thereof in use;

FIGS. 6 and 7 are similar views to those of FIGS. 2 and 3, respectively, of a second embodiment of a conveyer roller incorporating braking apparatus according to the invention;

FIG. 8 is a sectional side view of the roller of FIGS. 6 and 7; and

FIGS. 9 and 10 show auxiliary braking apparatus of the invention in a first, inoperative position and a second, braking position thereof, respectively.

### DESCRIPTION OF EMBODIMENTS

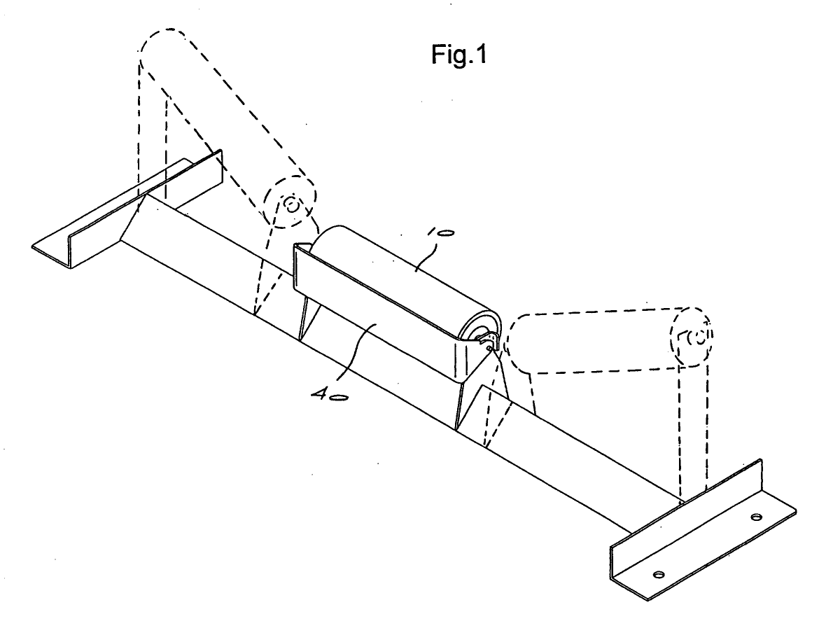

FIG. 1 shows a frame which supports a set of idler rollers intended for use in a conveyer installation. A central, horizontal roller is flanked by inclined wing rollers, for supporting a conveyer belt in a troughed configuration, which is conventional as such. However, the central roller is fitted with a belt braking mechanism according to the present invention, which will be described below in more detail.

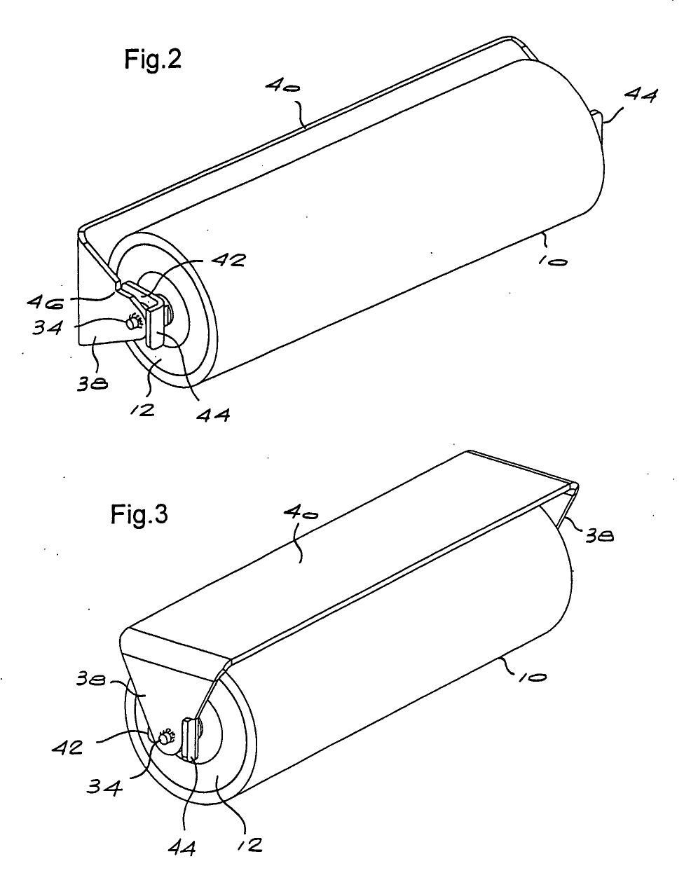

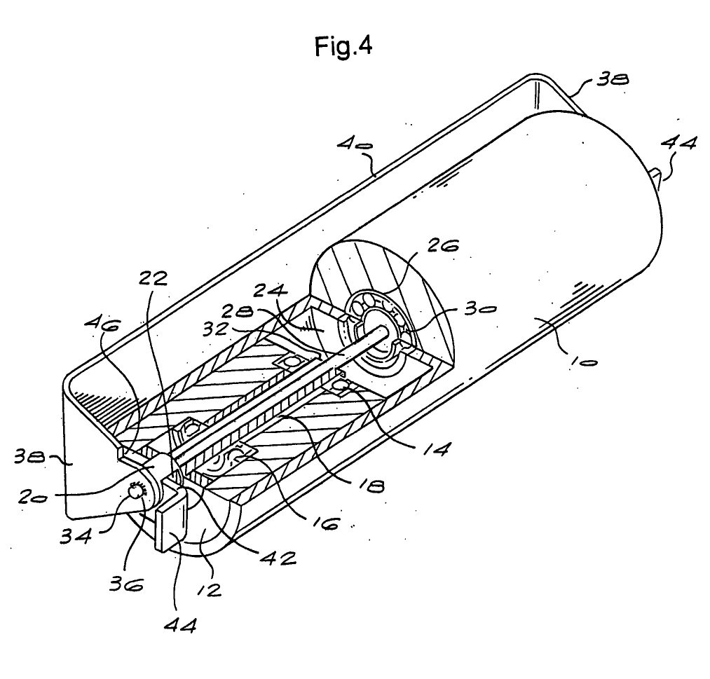

Referring now to FIGS. 2, 3 and 4, a conveyer idler roller 10 comprises a cylindrical tube or shell, typically formed of high density polyethylene (HDPE) or steel tubing, on which a conveyer belt runs in use. The illustrated shell 10 is formed from HDPE and is fitted with solid cylindrical end plugs 12 of HDPE or another suitable plastics material. Each plug 12 has a length of approximately 80 mm in the prototype system.

Each plug 12 supports inner and outer roller bearings 14 and 16 which are received in respective bores in the plug, at opposite ends thereof. The bearings 14 and 16 are fitted to a stub axle 18, so that the shell 10 of the idler roller is freely rotatable about the stub axles 18. Each stub axle 18 has an end portion 20 which extends beyond the end of the shell 10 and the plug 12, and has a pair of opposed flats 22 formed in it to enable the ends of the stub axles 20 to be dropped into suitably shaped slots in a support bracket.

As described so far, the construction of the idler roller is generally conventional, except that such rollers generally have a unitary axle extending the length of the idler roller, with a single roller bearing located near each of the opposed ends of the roller.

At the center of the shell 10, the material of the shell extends inwardly to define a diametric wall 24 in which is seated a one-way roller clutch bearing 26. Such bearings are commercially available, for example, from SKF and other manufacturers of bearings. The outer ring of the bearing 26 is a tight fit in a circular opening defined in the wall 24. A cylindrical shaft 28 is a tight fit in the central opening 30 of the roller clutch bearing, and extends beyond the outer ends of the roller through a bore 32 formed in the stub axle 18, in which the shaft 28 is freely rotatable.

The outer ends outer ends 34 of the shaft 28 pass through holes 36 formed in triangular brackets 38 which extend transversely from opposed ends of a flat braking plate 40 which extends adjacent the roller. Where the shaft 28 passes through the apertures 36, it is welded to the metal of the brackets 38. Thus, the braking plate 40 pivots with the shaft 28 about the same axis as the stub axles 18 of the idler roller assembly.

Fitted to the extreme ends of the stub axles 18 are locking members, each comprising a generally U-shaped bracket 42 with an outwardly extending flange 44 at one end thereof. The U-shaped bracket 42 defines an opening that is sized to fit snugly over the opposed flats 22 at the end of the stub axle 18, and the bracket is then tack welded into position on the end of the stub axle. The flats 22 are sufficiently wide to accommodate both the brackets 42 and a mounting bracket for the idler roller assembly, enabling the idler roller assembly to be mounted in the same way as a conventional idler roller.

A notch 46 is formed in one edge of each of the triangular brackets 38 which engages the L-shaped flange 44 of the locking member in use, as described below.

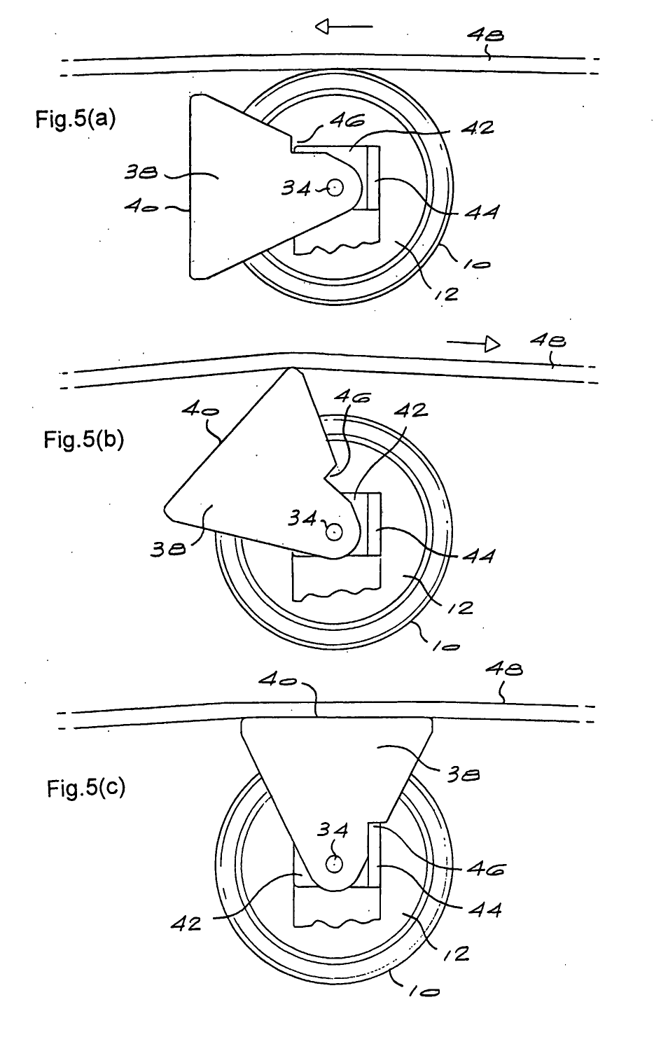

Referring now to FIGS. 5a to 5c, which are end views of the roller assembly of FIGS. 2 to 4, the operation of the braking mechanism of the invention will be described in greater detail. Referring first to FIG. 5a, the idler roller of the invention is disposed beneath a conveyer belt 48, traveling in the direction of the arrow. The belt and any load on it are supported by the roller, and the roller rotates counterclockwise as the belt moves. The brake member 40 is in a first, inoperative position adjacent the underside of the belt 48, and the roller clutch bearing 26 turns freely in its forward direction.

In the event of a belt breakage, causing the belt to reverse direction as indicated by the arrow in FIG. 5b, the direction of rotation of the roller is reversed, causing the roller clutch bearing 26 to lock. As the roller rotates counterclockwise together with the reversing belt, the shaft 28 rotates with it, pivoting the brake member 40 upwards into engagement with the underside of the belt 48. Once the upper edge of the brake member engages the underside of the belt, it is pulled by the belt clockwise into its second, braking position shown in FIG. 5c, in which the flat surface of the brake member engages the underside of the belt fully. The notches 46 in the triangular end plates of the brake member engage the respective flanges 44 on the locking members at each end of the roller, holding the brake member in the correct position under the belt.

In a prototype roller of the invention, the above described braking mechanism was applied to a center idler roller of 400 mm length and 127 mm outside diameter, and the braking member was formed from 5 mm mild steel plate, supported on a mild steel shaft of 8 mm diameter. The one-way clutch roller bearing was conservatively rated to withstand a torque of 30 Nm.

The surface finish of the brake member can be selected according to requirements. In the prototype, the steel plate used to form the brake member had a checkered or waffled pattern, making it suitable for use with a conveyer belt having a rubber undersurface. In some cases, a smooth metal finish may be preferred. It is also possible to coat or paint the brake member, for example with a layer of epoxy based primer with a relatively coarse texture, in order to increase the friction between the brake member and the belt in use. If required, a friction lining with desired frictional characteristics could be applied to the brake member.

In a typical installation, the conveyer belt 48 could be a multi-ply belt with a top layer of rubber, a fibre reinforcing layer and a bottom layer of rubber which is somewhat thinner than the top layer. Alternatively, a steel reinforced rubber belt, comprising a rubber belt body with a core of steel cables, might be used. In the latter case, a belt of 1050 mm width has a mass of approximately 45 kg/m, and might be rated to carry a load of approximately 40 to 50 kg/m. Depending on the angle of inclination of the conveyer, this creates a substantial longitudinal force in the event of breakage of the belt near the head roller of the conveyer. Experiments showed that a conveyor installation having a belt inclined at 12° to the horizontal, and utilising the above described prototype rollers in a troughed configuration and with a brake member 100 mm wide, required approximately 15 to 20% of the conventional centre idlers to be replaced in order to provide sufficient braking capacity, with a suitable safety margin, for efficient braking of the conveyer belt.

The above described conveyer belt braking mechanism is relatively simple in design and construction, and has the advantage that it does not require a separate, external installation to be added to a conveyer system, but merely the replacement of conventional idler rollers with the special rollers of the invention.

Compared with prior art braking rollers, where friction between the roller itself and the underside of the belt is used to provide a braking force, the braking mechanism of the invention has a much greater braking surface area. In the above described example, the area of contact between the belt and the surface of the roller is approximately 10 mm wide, compared with the width of the braking member of 100 mm. It will be appreciated that the brake member can be made even wider if required, and it may be provided with a friction surface which is superior to the conventional HDPE or steel roller surface. If required, the surface of the brake member can be curved convexly to match the curvature of the belt due to the sagging of the belt between rollers, to enhance contact between the belt and the brake member.

Because the one-way roller clutch bearing 26 is used only to pivot the brake member into position under the belt, and not to apply the braking force to the belt, a relatively small and inexpensive roller clutch bearing can be utilised for this purpose.

It will be appreciated that the brake member of the above described apparatus engages the underside of the belt fully after a quarter turn of the associated idler roller, so that the belt does not move far before it is braked and stopped.

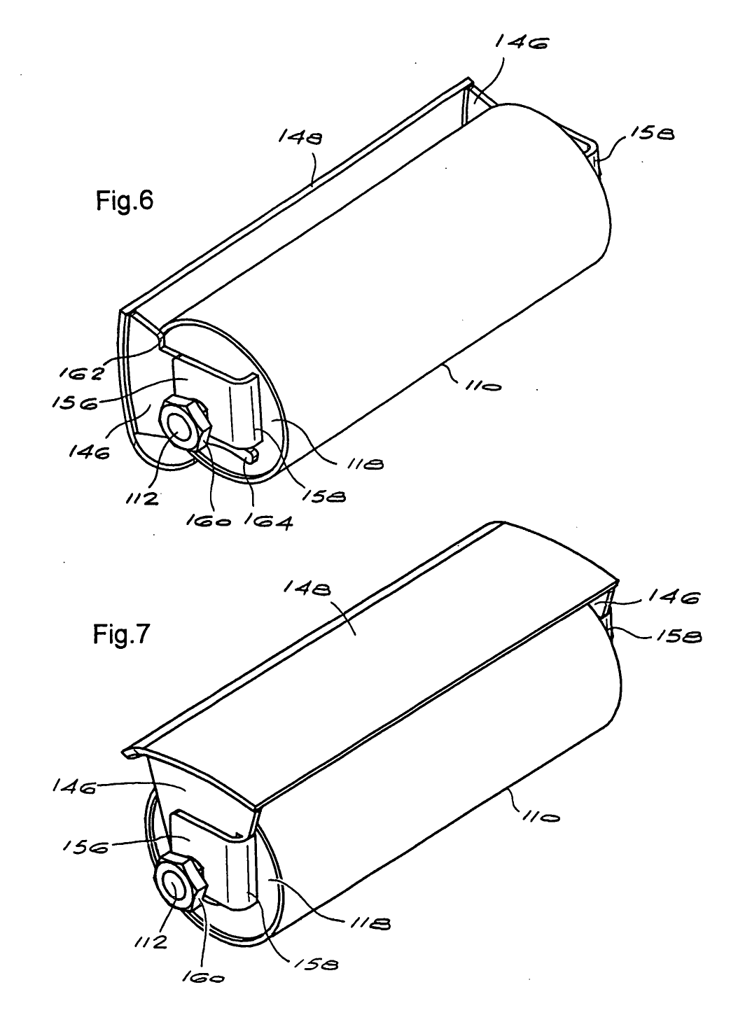

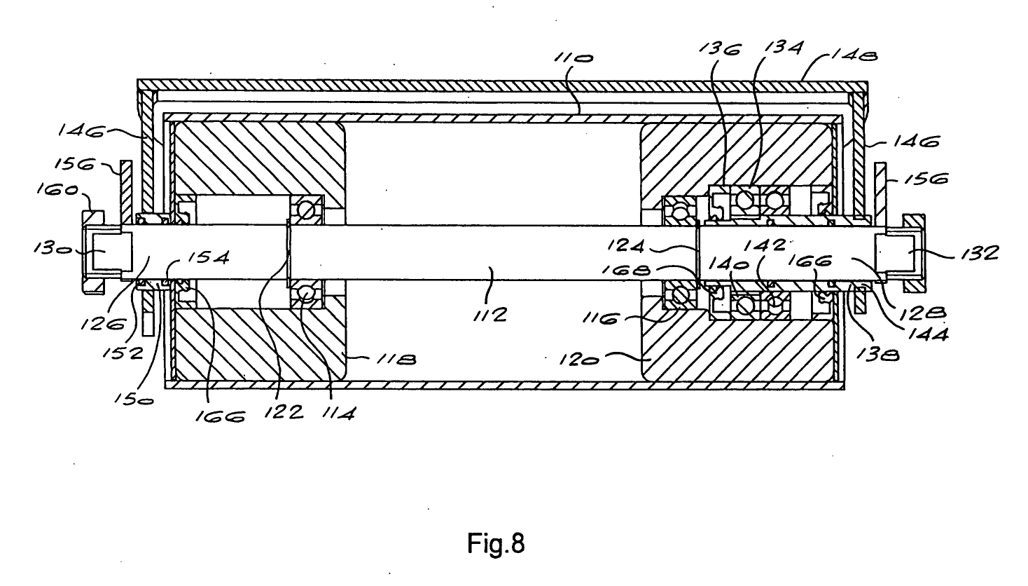

FIGS. 6, 7 and 8 show a second embodiment of the roller and associated braking apparatus. In this embodiment, the roller has a full-length shaft or axle 112 instead of a pair of stub-axles, which support the roller shell 110 on roller bearings 114 and 116. The bearings 114 and 116 are received in respective bores in plugs or end caps 118 and 120 and are held in position by clips 122 and 124. The shaft 112 has end portions 126 and 128 which extend beyond the end of the shell 110, and has a pair of opposed flats 130 and 132 formed in it at each end of the shaft to enable the ends of the shaft to be dropped into suitably shaped slots in a support bracket.

At one end of the roller shell 110, the plug 120 supports a one-way roller clutch bearing 134 similar to that described above. The outer ring of the bearing 134 is a tight fit in the wall 136 of the plug 120. A clutch sleeve 138 formed from stainless steel is a tight fit in the inner ring 140 of the roller clutch bearing 134 and extends beyond the outer end of the roller around the shaft 112. The clutch sleeve 138 is freely rotatable around the shaft 112 and is supported by a roller bearing 142.

The outer end 144 of the clutch sleeve 138 supports one of two triangular brackets 146 which extend transversely from opposed ends of a curved braking plate 148 which extends adjacent and parallel to the axis of the roller. The other bracket 146 is supported by a brass bush 150. The bracket can rotate about the bush, which can itself rotate about the shaft 112 on a pair of O-rings 152 and 154. Where the clutch sleeve 138 supports the triangular bracket 146 it is welded to the metal of the bracket. Thus, the braking plate 148 pivots with the clutch sleeve 138 about the shaft 112 of the idler roller assembly.

Fitted to the ends of the shaft 112 are locking members, each comprising a generally U-shaped bracket 156 which is generally L-shaped in section, with an inwardly extending flange 158 at one end thereof. Each U-shaped bracket 156 is sized to fit snugly over the opposed flats 130, 132 at the ends of the shaft 112, and the bracket is then tack welded into position on the end of the shaft. The flats 130, 132 are sufficiently wide to accommodate both the brackets 156 and a mounting bracket for the idler roller assembly, enabling the idler roller assembly to be mounted in the same way as a conventional idler roller. The idler roller is secured in the support bracket by means of lock nuts 160 on both ends of the shaft 112.

A notch 162 is formed in one edge of each of the triangular brackets 146 which engages the flange 158 of the locking member in use, in the same way as described above. The triangular brackets 146 have a finger 164 that rests against the lowermost end of the flange 158 and keeps the braking plate 148 in a vertical position when inoperative, as shown in FIG. 6.

The inner part of the roller shell 110 is protected from dust and moisture by means of seals 166. The clutch sleeve 138 has an inner seal 168 to keep lubricants on the roller clutch bearing 134.

The second embodiment of the roller/brake apparatus operates similarly to the first embodiment. If the roller reverses direction, the roller clutch bearing locks and the clutch sleeve 138 rotates the brake member 148 into engagement with the underside of the belt in the same way as described above with reference to the first embodiment.

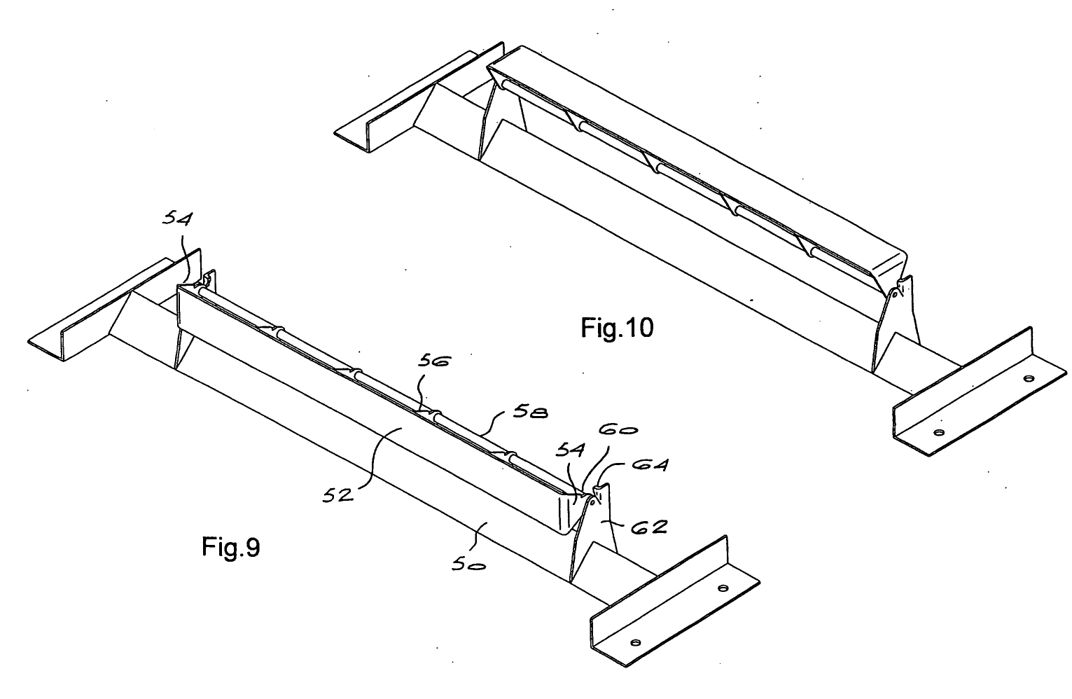

FIGS. 9 and 10 show an auxiliary braking mechanism designed for use adjacent the return run of a conveyer belt fitted with the above described braking apparatus. Referring first to FIG. 9, a bracket 50 supports an auxiliary brake member 52 which extends approximately the full width of the belt. The brake member 52 is, again, formed from steel plate with transversely extending triangular brackets 54 at each end, with additional reinforcing brackets 56 being provided to secure the brake member to a shaft 58. The shaft is fixed to the brackets 54, which are formed with notches 60 similar to the notches 46 described above, and upstanding brackets 62 which carry the shaft 58 pivotably are formed with integral locking or stop members 64 which engage the notches 60 in the same manner as the flanges 44 described above.

A linkage (not shown) connects the brake member 52 to a brake member 40 (or 148) of a corresponding idler roller, so that when the brake member of the idler roller is moved into its second, braking position, the brake member 52 is pivoted from the inoperative position shown in FIG. 9 to the braking position shown in FIG. 10, engaging the belt and helping to brake it. In some instances, the auxiliary braking mechanism of FIGS. 9 and 10 could be used independently of the braking rollers described above, with a different operating mechanism.

It will be appreciated that the braking apparatus of the invention could be implemented in a number of different ways. For example, although the use of a one-way roller clutch bearing housed within an idler roller is an elegant way of operating the brake member of the apparatus, another separate operating mechanism could be used to move the brake member into its operative position. Thus, the brake member of the invention could be installed adjacent a conventional idler roller and an external mechanism used to operate it.

1. Conveyer belt braking apparatus comprising:
an idler roller rotatable about an axle;
a brake member mounted adjacent the idler roller and movable relative to the roller between a first, inoperative position adjacent a belt supported by the roller and a second, braking position against the belt; and
an operating mechanism arranged to sense the direction of rotation of the roller and to move the brake member from the first, inoperative position to the second, braking position when the direction of rotation of the roller reverses in use.

2. Conveyer belt braking apparatus according to claim 1 wherein the brake member is arranged to be located between the belt and the roller when the brake member is in the second, braking position.

3. Conveyer belt braking apparatus according to claim 1 or claim 2 wherein the brake member is a plate mounted parallel to the roller and pivotable between the first and second positions.

4. Conveyer belt braking apparatus according to claim 3 wherein the plate is pivotable about an axis that coincides substantially with the axle of the roller.

5. Conveyer belt braking apparatus according to claim 4 wherein the plate is connected to a shaft that extends through a bore in the axle of the idler roller, the shaft being rotatable relative to the axle, with a one-way clutch mechanism within the body of the idler roller fixed to the shaft and to the body of the roller, so that the roller can rotate freely relative to the shaft in a forward direction but, when the roller rotates in a reverse direction, the clutch engages, causing the shaft to rotate and to move the brake member from the first, inoperative position to the second, braking position thereof.

6. Conveyer belt braking apparatus according to claim 4 wherein the plate is connected to a sleeve fitted about the axle, the sleeve being rotatable relative to the axle, with a one-way clutch mechanism within the body of the idler roller fixed to the sleeve and to the body of the roller, so that the roller can rotate freely relative to the sleeve in a forward direction but, when the roller rotates in a reverse direction, the clutch engages, causing the sleeve to rotate and to move the brake member from the first, inoperative position to the second, braking position thereof.

7. Conveyer belt braking apparatus according to any one of claims 1 to 6 including at least one locking member associated with the idler roller and arranged to engage the brake member and to hold the brake member in the second, braking position thereof when the brake member moves from the first, inoperative position thereof to the second, braking position thereof.

8. Conveyer belt braking apparatus according to claim 7 wherein said at least one locking member comprises a bracket fixable to the axle of the roller and having a projection that engages a portion of the brake member when the brake member moves to the second, braking position thereof.

9. Conveyer belt braking apparatus comprising:
a brake member mountable adjacent the return path of a conveyer belt and movable relative to the conveyer belt between a first, inoperative position adjacent the return path of the belt and a second, braking position in which the brake member engages the belt frictionally; and
an operating mechanism responsive to a belt breakage to move the brake member from the first position to the second, braking position thereof.

10. Conveyer belt braking apparatus according to claim 9 wherein the brake member is a plate mounted adjacent and transverse to the return path of the conveyer belt, the brake member being pivotable between the first and second positions.

11. Conveyer belt braking apparatus according to claim 9 or claim 10 wherein the operating mechanism is a linkage connecting the brake member to a brake member of a conveyer belt braking apparatus according to any one of claims 1 to 8.
